(19) United States
(12) Patent Application Publication
(10) Pub. No.: US 2006/0116306 A1
(43) Pub. Date: Jun. 1, 2006

(54) Acidic solids

(76) Inventors: Anja Patien, LANGENFELD (DE); Dietmar Rossner, Hilden (DE); Ralf Krack, Dusseldorf (DE)

Correspondence Address: ECOLAB INC., MAIL STOP ESC-F7, 655 LONE OAK DRIVE, EAGAN, MN, 55121, US

(21) Appl. No.: 10/536,546

(22) PCT Filed: Nov. 6, 2003
(86) PCT No.: PCT/EP03/12365

§ 371 Date: May 26, 2005

(30) Foreign Application Priority Data
Dec. 6, 2002 (DE) 102 57 390.5

(51) Int. Cl. C11D 17/00

(52) U.S. Cl. 510/191

(57) ABSTRACT

The invention relates to acidic cleaning compositions in the form of solid blocks which contain citric acid and one or more acids selected from adipic, succinic and glutaric acid as acidic components and to their production and use.

This invention relates to acidic cleaning compositions in the form of solid blocks which contain citric acid and one or more acids selected from adipic, succinic and glutaric acid as their acidic components.

The invention also relates to the production and use of these cleaning blocks.

Cleaners for hard surfaces which are suitable for use in public buildings and elsewhere (in the institutional or non-institutional sector) may assume numerous different forms. These cleaners are typically liquid formulations, specifically either non-aqueous organic cleaning formulations or aqueous cleaning formulations which, once diluted to yield ready-to-use solutions, may be neutral, acidic or alkaline. Organic cleaning formulations are usually produced in an organic base material, for example a solvent or surfactant. These formulations may furthermore contain a plurality of additives, such as sequestering agents, corrosion inhibitors etc.

Aqueous neutral, acidic or alkaline cleaners in the concentrations in which they are present in the ready-to-use solutions are typically formulated in such a manner that a relatively large quantity of an aqueous diluent and smaller, but effective, quantities of surfactants, auxiliary solvents and sequestering agents are used. These cleaners are often used as an aqueous concentrate and are diluted with water to form the ready-to-use solution. These diluted liquid cleaning formulations have proved useful in many areas of application. However, diluted liquid cleaning formulations which contain a relatively large proportion of an aqueous or organic diluent often result in high transport costs for the solvent or the water. Moreover, cleaning concentrates in liquid form may often be contaminated or they may also suffer spoilage, undergo phase separation and become unusable. Moreover, liquid substances may be spilt or splashed or otherwise incorrectly used, resulting in a safety risk for the user on contact with the alkaline or acidic concentrate. Cleaners in block form may be an advantageous alternative in such cases. It is known that inorganic, alkaline solids may be cast known methods. Fernholz, U.S. reissue patent 328,183 discloses a cleaner in the form of a solid block containing a high proportion of alkali. Morganson et al., U.S. Pat. No. 4,624,713 discloses a solid cleaner which contains a release control additive in order to allow release of the surfactant to be varied. Heile et al., U.S. Pat. Nos. 4,680,134 and 4,595,520, disclose a cleaner with little alkali which may optionally contain various inorganic solids. Solid inorganic fertilizers are disclosed in U.S. Pat. Nos. 4,175,943 by Jordan et al. and 4,260,592 by Corver et al. These patent publications primarily relate to particulate, inorganic fertilizer compositions which contain a mixture of substances optimized for the purposes of fertilizing growing plant tissue. These formulations are not very acidic and do not contain any ingredients which provide the cleaning performance of acidic cleaners.

We are not aware of any methods for solving the problem other than melting and casting solid acids in moulds or tabletting crystalline acids by means of pressure or microwaves.

Attempts to produce acidic solids by crystallization from supersaturated solutions have always failed because the mixtures crystallized irregularly, did not become solid despite being supersaturated or separated into solid and liquid phases.

With many mixtures, water was released again during storage and undesirable reactions, for example decomposition with formation of gas, even occurred in some cases.

Storable acidic solids could not be produced even by forming adducts with urea.

All previous attempts to melt solid acids and have them solidify in moulds to form acidic solids have met with failure. One requirement in this regard is that these acids should have a melting point below their decomposition temperature. Their melting point should preferably be between 60 and 80° C. It is particularly important to bear in mind that, where a standard packaging material consisting of polyethylene is used, packaging cannot be carried out at temperatures above 70° C. for material-specific reasons. This in turn means that flowability must be guaranteed at temperatures around and below 70° C. so that packaging can proceed smoothly.

Accordingly, the problem addressed by the invention was to provide acidic cleaners in block form, so-called “acidic solids”, which would meet requirements with regard to the production process, storage stability and usability in existing solid processes, preferably packed in PE capsules, and to cleaning performance.

The present invention accordingly relates to an acidic cleaner in block form containing the components
a) citric acid and
b) one or more acids, preferably at least two and more preferably all three acids selected from adipic, succinic and glutaric acid.

Where all three acids are present, it is particularly favorable if they are present in the ratio to one another which is found in the product Sokalan® DCS currently marketed by BASF.

In the preferred embodiment, the cleaner according to the invention has a total water content of at most 20% by weight, more preferably of less than 15% by weight and most preferably of less than 13% by weight, based on the cleaner as a whole.

The lower limit to the total water content in the cleaner according to the invention is preferably at least 1% by weight and more preferably at least 3% by weight, based on the cleaner as a whole.

In a preferred embodiment of the cleaner according to the invention, the ratio of component a) to component b) is (20 to 60):(20 to 60) and preferably (30 to 50):(30 to 50).

In another preferred embodiment of the cleaner according to the invention, the acidic cleaner in block form contains as an additional acidic component c) an acid selected from lactic acid, phosphoric acid, alkyl benzenesulfonic acid or alkanesulfonic acids with 1 to 4 C atoms in the alkane chain. In a particularly preferred embodiment, lactic acid is present as the additional acidic component c).

Where both an acid from groups a) and b) and an acid from group c) are present, it is particularly favorable for the cleaner according to the invention if the ratio of component a) to component b) to component c) is (20 to 60):(20 to 60):(10 to 30) and preferably (30 to 50):(30 to 50):(10 to 30).

In addition to the ingredients already mentioned, other preferred ingredients of the cleaning block according to the invention are auxiliaries and active ingredients selected from cleaning and defoaming surfactants, other defoamers, antimicrobial components and other components which are useful for achieving the required effect.

The cleaner according to the invention preferably contains at least one surfactant selected from nonionic, anionic, cationic, amphoteric and polymeric surfactants as surfactant components.

Surfactants produce a change in the surface tension of final compositions and promote the removal and suspension of soil by emulsifying the soil which may then be removed by subsequent rinsing.

Anionic surfactants are useful for removing oil-containing soils. In general, anionic surfactants are relatively hydrophobic, so that they may be used in cleaning processes, such as the washing of hard surfaces and in laundries for cleaning items with oil deposits. Surfactants which may be used for the invention include, inter alia, sulfates, sulfonates and carboxylates, such as for example alkyl carboxylate salts. Examples of anionic surfactants are alkyl sulfates and sulfonates, alkyl ether sulfates and sulfonates, alkyl aryl sulfates and sulfonates, aryl sulfates and sulfonates and sulfated fatty acid esters. Preferred anionic surfactants include linear alkyl sulfates and sulfonates and alkyl benzyl sulfates and sulfonates. Alkyl groups with a carbon chain length of between about C₈ and C₁₈ are more preferred; the preferred aryl group is benzyl.

Nonionic surfactants which have generally proved useful for the invention are surfactants which contain ethylene oxide, propylene oxide and mixtures thereof. These nonionic surfactants have proved to be pH-stable in an acidic environment and effective in cleaning and in the suspension of soil.

Nonionic surfactants of use for the invention include nonionic polyoxyalkylene surfactants, such as C₈₋₂₂ normal fatty alcohol ethylene oxide or propylene oxide condensation products (i.e. condensation products of 1 mol of fatty alcohol having 8 to 22 carbon atoms with 2 to 20 mol of ethylene oxide or propylene oxide); polyoxypropylene/polyoxyethylene condensation products of the formula HO(C₂H₄O)ₓ(C₃H₆O)_{y}H, where (C₂H₄O)ₓ makes up at least 15% of the polymer and (C₃H₆O)_{y} makes up 20 to 90% of the total weight of the compound; alkyl polyoxypropylene/polyoxyethylene condensation products of the formula RO—(C₃H₆O)ₓ(C₂H₄O)_{y}H, where R represents a C₁₋₁₅ alkyl group and x and y are each integers of 2 o 98; polyoxyalkylene glycols; butylene oxide-bridged alcohol ethoxylate with the formula (R(OC₂H₄)_{y}(OC₄H₈)ₓOH, where R represents a C₁₈ alkyl group, y represents a number between approximately 3.5 and 10 and x is an integer of about 0.5 to 1.5; polyoxyethylene benzyl ethers and condensation products of alkyl phenols corresponding to the formula R(C₆H₄)(OC₂H₄)ₓOCH₂C₆H₅, where R represents a C₆₋₂₀ alkyl group and x is an integer of 5 to 40; and alkyl phenoxy polyoxyethylene ethanols with the formula R(C₆H₄)(OC₂H₄)ₓOH, where R represents a C₈₋₂₀ alkyl group and x is an integer of 3 to 20. Two particular kinds of nonionic surfactants have proved to be particularly effective soil suspending agents in the solid cleaning composition according to the invention. Firstly, polyoxypropylene/polyoxyethylene block copolymers have proved useful for the invention. These polymers correspond to the general formula: 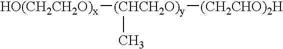
where on average x=0-150, preferably 2-128, y=0-150, preferably 16-70, and z=0-150, preferably 2-128. The polyoxypropylene/polyoxyethylene block copolymers used in the invention, where x=2-40, y=30-70 and z=2-40, are more preferred. Nonionic block copolymers with this formula are desirable for many applications due to the reduced foaming which they impart. Alcohol ethoxylates form a second preferred group of nonionic surfactants which are useful for the invention and desirable for other applications. These nonionic surfactants are formed by reacting an alcohol salt (RO⁻Na⁺), where R is an alcohol group or an aromatic alkyl group, with an alkylene oxide. Preferred alkoxylates are generally C₈₋₂₂ alkyl alkoxylates, such as lauryl ethoxylate, which correspond to the following general formula:
R—(OCH₂CH₂)ₙOH,
where the value of n may be between 1 and 100. However, a C₁₋₁₂ alkyl phenol structural unit may be preferred to the alkyl group for ecological reasons.

Amine oxide surfactants are among the surfactants which are particularly suitable for use in acidic systems. Suitable amine oxides correspond to the following formula: 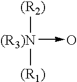
where R₁ represents a C₈-C₂₀ alkyl or a C₈-C₂₀ alkylamido-C₂-C₅-alkyl group and R₂ and R₃ each represent a lower C₁-C₄ alkyl or a lower C₁-C₄ hydroxyalkyl. Preferably, both R₂ and R₃ are methyl, ethyl or 2-hydroxyethyl. Preferred representatives of this group are, for example, lauryl (dimethyl) amine oxide (Ninox®L, Stephan Chemical Co., Northfield, Ill.), cocodimethyl amine oxide (Ninox®)C), myristyl (dimethyl) amine oxide (Ninox®M), stearyl (dimethyl) amine oxide (Schercamox®DMS, Scher Chemicals, Inc., Clifton, N.J.), coco(bis-hydroxyethyl) amine oxide (Schercamox®CMS), tallow (bis-hydroxyethyl) amine oxide and cocoamidopropyl (dimethyl) amine oxide (Ninox®CA). Although these surfactants are nonionic in alkaline solutions, they assume cationic properties in acidic solutions.

Cationic surfactants may also be used in quaternary ammonium compounds in the acidic cleaner according to the invention. Cationic surfactants, including quaternary ammonium chloride surfactants, such as N-alkyl(C₁₂₋₁₈)dimethylbenzyl ammonium chloride, N-tetradecyl-dimethylbenzyl ammonium chloride monohydrate, N-alkyl(C₁₂₋₁₄)di-methylnaphthylmethyl ammonium chloride, which are commercially available from such manufacturers as Stephan Chemical Company, are also useful as germ inhibitors for the purposes of the invention.

The surfactant composition may contain a mixture of nonionic and anionic surfactants. A preferred nonionic surfactant is a C₆₋₁₂ alkyl phenol ethoxylate with approximately 5 to 15 mol EO while a preferred anionic surfactant is a linear alkyl sulfate or sulfonate with an alkyl chain of approximately C₈₋₁₈. Overall, the surfactant composition in this preferred form makes up approximately 10 to 70% by weight, the anionic surfactant making up about 0 to 60% and, most preferably, 1 to 55% by weight of the composition as a whole.

The cleaners according to the invention are not normally marketed and used in unpackaged form. As already mentioned in the description, such products are generally packed in plastics capsules and also remain in these capsules during use.

Accordingly, in another preferred embodiment of the present invention, the acidic cleaning block is surrounded by a plastic capsule which, in a particularly preferred embodiment, consists largely of polyethylene.

The embodiment according to the invention of the acidic cleaning block is solid preferably at room temperature, more preferably at temperatures of up to 35° C. and most preferably at temperatures of up to 50° C.

The present invention also relates to a process for the production of an acidic cleaner in block form according to the invention, the process comprising the steps of
a) initially introducing preferably deionized water, bearing in mind that the quantity of water should be selected so that the total water content amounts to at most 20% by weight, preferably to less than 15% by weight and more preferably to less than 13% by weight, based on the cleaner as a whole,
b) adding the acids present in accordance with the invention and optionally other auxiliaries and active ingredients and
c) cooling the mixture to room temperature, preferably in a plastic capsule, more preferably in a polyethylene capsule.

This version of the production process according to the invention may be regarded as a melting/dissolving operation. The starting components, particularly the acids, are preferably water-free. However, it is equally possible to use acids which contain water of crystallization or other water. In a particularly preferred embodiment, however, components a) and b) are water-free. It may be preferred from case to case for component c) to introduce all or part of the required quantity of water into the production process.

Initially introducing the stated quantities of water ensures that the operation may be carried out at a sufficiently low temperature.

In addition, the total quantity of water helps to ensure that the product is still flowable at temperatures of around 50 to 75° C. and can be packed in plastics capsules.

This is of considerable significance in particular because, it is possible as a consequence to pack the melt in the temperature-sensitive polyethylene (PE) capsules conventionally used for such fused blocks.

This factor is all the more significant in view of the fact that manufacturers of PE capsules are attempting to save ever greater quantities of material with the result that the capsule walls are becoming even thinner than before. In some tests, holes were even formed in the polyethylene capsules which is, of course, a serious quality problem.

In the above-mentioned production process according to the invention, it is preferred to add the acid c) optionally used first, then acid a) and finally acid b).

The present invention also relates to the use of an acidic cleaning block according to the invention for the preparation of aqueous cleaning solutions by dilution with water by a factor of 20 to 10,000.

The present invention also relates to the use of a cleaning solution obtainable by dilution of an acidic cleaning block according to the invention with water by a factor of 20 to 10,000 for cleaning surfaces in the institutional, industrial and agricultural sectors, such cleaning solutions preferably being used for dishwashing or cleaning membranes.

The present invention further relates to the use of a cleaning solution obtainable by dilution of an acidic cleaning block according to the invention with water by a factor of 20 to 10,000 for dishwashing or cleaning membranes.

### EXAMPLES

The tests presented in Tables 1 to 3 are intended to illustrate the invention.

TABLE 1
Compositions (% by weight) of formulations according
to the invention (E) and comparison formulations (V)

| Ingredients | E1 | E2 | E3 | E4 | V1 | V2 | V3 |
|---|---|---|---|---|---|---|---|
| Citric acid | 40 | 40 | 40 | 42.5 | 60 | 60 | 50 |
| Adipic acid | ˜13.6 | ˜13.6 | ˜13.6 | ˜13.6 | | | |
| Succinic acid | ˜16 | ˜16 | ˜16 | ˜16 | | | |
| Glutaric acid | ˜10.4 | ˜10.4 | ˜10.4 | ˜10.4 | | | |
| Lactic acid | 9 | 8 | | | | | |
| Phosphoric acid | | 1 | | | | | |
| Alkyl benzene | | | 1 | | | | |
| sulfonic acid | | | | | | | |
| Methanesulfonic | | | 9 | | | | |
| acid | | | | | | | |
| Glycolic acid | | | | | | 25 | |
| Maleic acid | | | | | 20 | | |
| Total water | 11 | 11 | 10 | 15 | 20 | 15 | 50 |

*Total water represents the total percentage of water present in the formulation (incl. any water of crystallization already present in the raw materials)

TABLE 2
Evaluation of the formulations according to the invention
and comparison formulations set out in Table 1 in the
production process on the basis of their handling behavior
at temperatures of around 70° C.

| Formulation | Properties in the production and packaging process |
|---|---|
| E1 | Represents a clear melt/solution at ca. 75° C. and is free- |
| | flowing at <70° C. and can be packaged at <70° C. without |
| | any problems |
| E2 | Represents a clear melt/solution at ca. 75° C. and is free- |
| | flowing at <70° C. and can be packaged at <70° C. without |
| | any problems |
| E3 | Represents a clear melt/solution at ca. 75° C. and is free- |
| | flowing at <70° C. and can be packaged at <70° C. without |
| | any problems |
| E4 | Represents a clear melt/solution at ca. 75° C. and is free- |
| | flowing at <70° C. and can be packaged at <70° C. without |
| | any problems |
| V1 | Represents a clear melt/solution at ca. 75° C. and is free- |
| | flowing at <70° C. and can be packaged at <70° C. without |
| | any problems |
| V2 | Represents a clear melt/solution at ca. 75° C. and is free- |
| | flowing at <70° C. and can be packaged at <70° C. without |
| | any problems |
| V3 | The melting point is just above 100° C.; handling in the |
| | production and packaging process is poor at the normally |
| | preferred temperatures of ca. 70° C. |

TABLE 3
Evaluation of the formulations according to the invention
and comparison formulations stated in Table 1 with regard
to the nature of the finished product obtained

| Formulation | Nature of the finished product |
|---|---|
| E1 | Acidic fused block solid at room temperature and at 35° C. |
| E2 | Acidic fused block solid at room temperature and at 35° C. |
| E3 | Acidic fused block solid at room temperature and at 35° C. |
| E4 | Acidic fused block solid at room temperature and at 35° C. |
| V1 | Due to crystallization processes, a non-homogeneous, 2- |
| | phase end product is obtained after production |
| V2 | The consistency of the finished product is too soft or |
| | pasty; with this consistency, the finished product is |
| | unsuitable for use as an acidic fused block cleaner |
| V3 | Acidic fused block solid at room temperature and at 40° C. |

Analysis of the results according to Tables 2 and 3 shows that only formulations E1 to E4 according to the invention meet the requirements acidic fused block cleaners are expected to satisfy in practice.

1-18. (canceled)

19. An acidic cleaning block comprising:
a) citric acid; and
b) a second acid selected from the group consisting of adipic, succinic, glutaric, and mixtures thereof.

20. The acidic cleaning block of claim 19, wherein the cleaning block contains up to 20% by weight of water based on the cleaning block as a whole.

21. The acidic cleaning block of claim 19, wherein the cleaning block has up to 3% by weight of water based on the cleaning block as a whole.

22. The acidic cleaning block of claim 19, wherein the cleaning block contains at least two acids selected from the group consisting of adipic, succinic, glutaric, and mixtures thereof.

23. The acidic cleaning block of claim 19, wherein the ratio of citric acid to the second acid is (20 to 60):(20 to 60).

24. The acidic cleaning block of claim 19, further comprising a third acid selected from the group consisting of lactic acid, phosphoric acid, alkyl benzene sulfonic acid, alkanesulfonic acid having 1 to 4 carbon atoms in the alkyl chain, and mixtures thereof.

25. The acidic cleaning block of claim 19, further comprising lactic acid.

26. The acidic cleaning block of claim 19, wherein the ratio of citric acid, to the second acid to the third acid is (20 to 60):(20 to 60):(10 to 30).

27. The acidic cleaning block of claim 19, further comprising at least one surfactant selected from the group consisting of nonionic, anionic, cationic surfactants, and mixtures thereof.

28. The acidic cleaning block of claim 19, wherein the cleaning block is surrounded by a plastic capsule.

29. The acidic cleaning block of claim 19, wherein the plastic capsule is substantially polyethylene.

30. The acidic cleaning block of claim 19, wherein the acidic cleaning block remain solid up to temperatures of 35° C.
